(19) United States
(12) Patent Application Publication
(10) Pub. No.: US 2006/0221606 A1
(43) Pub. Date: Oct. 5, 2006

(54) LED-BASED LIGHTING RETROFIT SUBASSEMBLY APPARATUS

(75) Inventor: Kevin J. Dowling, Westford, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Color Kinetics Incorporated, Boston, MA (US)

(21) Appl. No.: 11/279,289

(22) Filed: Apr. 11, 2006

Related U.S. Application Data
(63) Continuation-in-part of application No. 11/081,020, filed on Mar. 15, 2005.
(60) Provisional application No. 60/670,367, filed on Apr. 11, 2005.
(60) Provisional application No. 60/553,111, filed on Mar. 15, 2004.
(60) Provisional application No. 60/558,400, filed on Mar. 31, 2004.
(60) Provisional application No. 60/558,449, filed on Mar. 31, 2004.

(51) Int. Cl. F21S 4/00

(52) U.S. Cl. 362/217

(57) ABSTRACT

LED-based lighting subassemblies that serve as retrofit apparatus for conventional lighting fixtures, such as fluorescent lighting fixtures. Various retrofit subassemblies need not be configured to resemble and/or directly replace conventional light bulb types. Rather, the retrofit subassemblies may employ a variety of mechanical (and electrical) support configurations to facilitate outfitting a conventional lighting fixture with LED light sources. In some examples, pre-existing conventional lighting fixtures are incorporated as fixed or recessed structures in an architectural environment, and an LED lighting subassembly provides a convenient apparatus for retrofitting such fixtures with light sources having higher energy efficiencies as well as a wider scope of possible light generating capabilities.

### CROSS-REFERENCES TO RELATED APPLICATIONS

The present application claims the benefit, under 35 U.S.C. § 119(e), of U.S. provisional application Ser. No. 60/670,367, filed Apr. 11, 2005, entitled “Methods and Systems for Providing Lighting Systems.”

The present application also claims the benefit, under 35 U.S.C. §120, as a continuation-in-part (CIP) of U.S. non-provisional application Ser. No. 11/081,020, filed Mar. 15, 2005, entitled “Methods and Systems for Providing Lighting Systems,” which in turn claims the benefit of the following U.S. provisional applications:

Ser. No. 60/553,111, filed Mar. 15, 2004, entitled “Lighting Methods and Systems;”

Ser. No. 60/558,400, filed Mar. 31, 2004, entitled “Methods and Systems for Providing Lighting Components;” and

Ser. No. 60/558,449, filed Mar. 31, 2004, entitled “Systems and Methods of Assembling and Connecting Solid State Lighting Modules.”

Each of the foregoing applications hereby is incorporated herein by reference.

### FIELD OF THE INVENTION

The present disclosure is directed generally to lighting apparatus including LED-based light sources that may be employed as subassemblies for retrofitting conventional lighting fixtures or fixture housings.

### BACKGROUND

A lighting fixture is an electrical device used to create artificial light or illumination in a variety of indoor or outdoor environments. In general, a complete lighting fixture includes one or more sources of light (sometimes referred to as “lamps”), one or more apertures that allow light to escape from the fixture, and an outer shell or housing that supports and/or protects the light source(s). A lighting fixture also may include one or more reflectors, transparent or translucent windows, diffusers, or other optical components that facilitate various desirable properties of light generated from the fixture (such optical components also may provide for a complete housing enclosure to safely enclose other fixture components inside the housing). A lighting fixture also typically includes some type of electrical and/or mechanical connection mechanism for coupling the lighting fixture to a source of power and, in some cases, an electrical ballast or other power conversion components to provide appropriate electrical operating conditions to the light source(s) from the fixture's source of power.

Lighting fixtures conventionally may be classified by how the fixture is installed in a given environment, the function of the light generated by the fixture, and/or the type of light source(s) employed in the fixture. Some examples of fixture classification based on installation or lighting function include free-standing or portable fixtures, recessed fixtures (e.g., wherein the housing is concealed behind a ceiling or wall), surface-mounted fixtures (e.g., wherein the housing is exposed), pendant fixtures (e.g., suspended from a ceiling with a chain or pipe), cove fixtures, track fixtures, under-cabinet fixtures, emergency or exit lighting fixtures, indirect fixtures (e.g., in which generated light is reflected off of walls or other surfaces), direct lighting fixtures, and down-lighting fixtures. Some examples of fixture classification based on type of light source(s) include incandescent fixtures, halogen fixtures, gas discharge (high intensity discharge, or HID) fixtures, fluorescent fixtures, and solid-state lighting fixtures.

Amongst lighting fixtures based on various types of light sources, fluorescent lighting fixtures have been employed ubiquitously for the past several decades, in home, office, institutional, commercial, industrial, and a host of other environments, as energy-efficient alternatives to incandescent and other types of lighting fixtures that use less efficient light sources. Fluorescent light sources are significantly more efficient than incandescent light sources of an equivalent brightness, because more of the energy consumed by a fluorescent light source is converted to usable light and less is converted to heat (allowing fluorescent lamps to operate at cooler temperatures than incandescent and other light sources). In particular, an incandescent lamp may convert only approximately 10% of its power consumption into visible light, while a fluorescent lamp producing as much useful visible light energy may require only one-third to one-quarter as much power. Furthermore, a fluorescent light source typically lasts between ten and twenty times longer than an equivalent incandescent light source. For at least the foregoing reasons, fluorescent lighting fixtures are popular choices for many lighting applications.

One example of a common conventional fluorescent lighting fixture is illustrated in FIG. 1. The fixture shown in FIG. 1 includes one or more fluorescent light sources or bulbs 2404. A fluorescent bulb uses electricity to excite mercury vapor in argon or neon gas, resulting in a plasma that produces short-wave ultraviolet light. This ultraviolet light then causes a phosphor to fluoresce, producing visible light. Several types of fluorescent bulbs commonly manufactured for many decades generally have the form of long tubes, as shown in FIG. 1; as a result, many types of fluorescent lighting fixtures are elongate in shape (e.g., essentially linear or rectangular) to accommodate long tube-like fluorescent bulbs. For example, as illustrated in FIG. 1, a housing 2402 of the fixture may have the form of an elongate (rectangular) pan or tray, in which is mounted one or more bulbs 2404.

Unlike incandescent lamps, fluorescent light sources always require an electronic ballast to regulate the flow of power through the light source. Accordingly, the fixture shown in FIG. 1 also includes a ballast 2410, which receives power (e.g., from an A.C. power source) via the wires 2414, and in turn provides appropriate electrical signals via the wires 2412 and 2416 to a pair of connectors or “sockets” which engage mechanically and electrically with the bulb 2404. One such socket 2408 is shown in FIG. 1, while the other socket is on an opposite wall of the housing 2402 (out of view in the perspective drawing of FIG. 1). As illustrated in FIG. 1, a common configuration for such sockets includes a bi-pin receptacle which mates with two pins of the bulb 2404, via which the electrical signals are applied to the bulb.

Another type of light source that may be employed in a lighting fixture is a semi-conductor or solid-state light source, one example of which is a light emitting diode (LED). LEDs have been growing in popularity as light sources for a wide variety of lighting fixture configurations for a variety of lighting applications. While fluorescent light sources historically have been popular in part because of their higher energy efficiency relative to incandescent sources, for example, LED sources have an even higher efficiency compared to fluorescent light sources. As a result, LED light sources provide an attractive alternative for high efficiency lighting fixtures.

Because of the appreciable efficiency of LEDs as light sources, there have been various efforts to provide LED-based retrofit light sources, such as LED-based light bulbs, that may be used as substitutes for other types of light sources (e.g., incandescent, halogen, fluorescent) in pre-existing conventional lighting fixtures. For example, U.S. Pat. No. 7,014,336, as well as U.S. Patent Application Publication No. 2002-0060526-A1, disclose replacement or retrofit bulbs for fluorescent tubes that include a plurality of LEDs (rather than mercury vapor in argon or neon gas) as light sources. These retrofit bulbs are designed to engage with the standard connectors (e.g., the connector 2408 shown in FIG. 1) typically found in conventional fluorescent lighting fixtures, thereby providing energy efficient alternative bulbs for these fixtures.

### SUMMARY

While LED-based retrofit light bulbs may provide various advantages over conventional bulb types in pre-existing lighting fixtures, including increased energy efficiency, Applicants have recognized and appreciated that other types of LED-based lighting subassemblies, having configurations different from conventional bulb types, may be employed as retrofit apparatus for conventional lighting fixtures. Accordingly, various embodiments of the present disclosure are directed to such LED-based lighting subassemblies.

More specifically, LED-based lighting subassemblies according to the present disclosure may serve as retrofit apparatus for conventional lighting fixtures, including fluorescent lighting fixtures. In various aspects, retrofit subassemblies need not be configured to resemble and/or directly replace conventional light bulb types; more specifically, retrofit subassemblies need not necessarily engage with one or more fluorescent bulb sockets or connectors of the conventional lighting fixture. Rather, the retrofit subassemblies may employ a variety of mechanical (and electrical) support configurations to facilitate outfitting a conventional lighting fixture with LED light sources. In some examples, pre-existing conventional lighting fixtures are incorporated as fixed or recessed structures in an architectural environment, and an LED lighting subassembly provides a convenient apparatus for retrofitting such fixtures with light sources having higher energy efficiencies as well as a wider scope of possible light generating capabilities.

In sum, one embodiment is directed to a lighting retrofit apparatus comprising at least one first LED, at least one controller coupled to the at least one first LED and configured to control at least a first intensity of first radiation generated by the at least one first LED, and a mechanical support to which at least the at least one first LED is coupled, the mechanical support configured such that the lighting retrofit apparatus constitutes a subassembly that is attachable to a housing of a conventional lighting fixture.

Another embodiment is directed to a lighting fixture, comprising a housing of a conventional fluorescent lighting fixture, and an LED-based retrofit subassembly coupled to the housing of the conventional fluorescent lighting fixture, wherein the LED-based retrofit subassembly does not engage with one or more conventional fluorescent bulb sockets of the conventional fluorescent lighting fixture.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like.

In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of from approximately 700 degrees K (typically considered the first visible to the human eye) to over 10,000 degrees K; white light generally is perceived at color temperatures above 1500-2000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The terms “lighting unit” and “lighting fixture” are used interchangeably herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present disclosure discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

The following patents and patent applications are hereby incorporated herein by reference:

U.S. Pat. No. 6,016,038, issued Jan. 18, 2000, entitled “Multicolored LED Lighting Method and Apparatus;”

U.S. Pat. No. 6,211,626, issued Apr. 3, 2001 to Lys et al, entitled “Illumination Components,”

U.S. Pat. No. 6,608,453, issued Aug. 19, 2003, entitled “Methods and Apparatus for Controlling Devices in a Networked Lighting System;”

U.S. Pat. No. 6,548,967, issued Apr. 15, 2003, entitled “Universal Lighting Network Methods and Systems;”

U.S. Pat. No. 6,717,376, issued Apr. 6, 2004, entitled “Methods and Apparatus for Controlling Devices in a Networked Lighting System;”

U.S. Pat. No. 6,965,205, issued Nov. 15, 2005, entitled “Light Emitting Diode Based Products;”

U.S. Pat. No. 6,967,448, issued Nov. 22, 2005, entitled “Methods and Apparatus for Controlling Illumination;”

U.S. Pat. No. 6,975,079, issued Dec. 13, 2005, entitled “Systems and Methods for Controlling Illumination Sources;”

U.S. patent application Ser. No. 09/886,958, filed Jun. 21, 2001, entitled Method and Apparatus for Controlling a Lighting System in Response to an Audio Input;”

U.S. patent application Ser. No. 10/078,221, filed Feb. 19, 2002, entitled “Systems and Methods for Programming Illumination Devices;”

U.S. patent application Ser. No. 09/344,699, filed Jun. 25, 1999, entitled “Method for Software Driven Generation of Multiple Simultaneous High Speed Pulse Width Modulated Signals;”

U.S. patent application Ser. No. 09/805,368, filed Mar. 13, 2001, entitled “Light-Emitting Diode Based Products;”

U.S. patent application Ser. No. 09/716,819, filed Nov. 20, 2000, entitled “Systems and Methods for Generating and Modulating Illumination Conditions;”

U.S. patent application Ser. No. 09/675,419, filed Sep. 29, 2000, entitled “Systems and Methods for Calibrating Light Output by Light-Emitting Diodes;”

U.S. patent application Ser. No. 09/870,418, filed May 30, 2001, entitled “A Method and Apparatus for Authoring and Playing Back Lighting Sequences;”

U.S. patent application Ser. No. 10/045,604, filed Mar. 27, 2003, entitled “Systems and Methods for Digital Entertainment;”

U.S. patent application Ser. No. 09/989,677, filed Nov. 20, 2001, entitled “Information Systems;”

U.S. patent application Ser. No. 10/163,085, filed Jun. 5, 2002, entitled “Systems and Methods for Controlling Programmable Lighting Systems;”

U.S. patent application Ser. No. 10/245,788, filed Sep. 17, 2002, entitled “Methods and Apparatus for Generating and Modulating White Light Illumination Conditions;”

U.S. patent application Ser. No. 10/325,635, filed Dec. 19, 2002, entitled “Controlled Lighting Methods and Apparatus;”

U.S. patent application Ser. No. 10/360,594, filed Feb. 6, 2003, entitled “Controlled Lighting Methods and Apparatus;”

U.S. patent application Ser. No. 10/435,687, filed May 9, 2003, entitled “Methods and Apparatus for Providing Power to Lighting Devices;”

U.S. patent application Ser. No. 10/828,933, filed Apr. 21, 2004, entitled “Tile Lighting Methods and Systems;”

U.S. patent application Ser. No. 10/839,765, filed May 5, 2004, entitled “Lighting Methods and Systems;”

U.S. patent application Ser. No. 11/010,840, filed Dec. 13, 2004, entitled “Thermal Management Methods and Apparatus for Lighting Devices;”

U.S. patent application Ser. No. 11/079,904, filed Mar. 14, 2005, entitled “LED Power Control Methods and Apparatus;”

U.S. patent application Ser. No. 11/081,020, filed on Mar. 15, 2005, entitled “Methods and Systems for Providing Lighting Systems;”

U.S. patent application Ser. No. 11/178,214, filed Jul. 8, 2005, entitled “LED Package Methods and Systems;”

U.S. patent application Ser. No. 11/225,377, filed Sep. 12, 2005, entitled “Power Control Methods and Apparatus for Variable Loads;” and

U.S. patent application Ser. No. 11/224,683, filed Sep. 12, 2005, entitled “Lighting Zone Control Methods and Systems.”

It should be appreciated that all combinations of the foregoing concepts and additional concepts discussed in greater detail below are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

FIG. 1 is a diagram illustrating a conventional fluorescent lighting fixture including a fluorescent light source in the form of a tube.

FIG. 2 is a diagram illustrating various elements of an LED-based lighting apparatus that may be configured as part of a retrofit subassembly, according to one embodiment of the disclosure.

FIG. 3 is a diagram illustrating a conventional lighting fixture retrofitted with an LED-based lighting subassembly, according to one embodiment of the disclosure.

FIG. 4 is a diagram illustrating a conventional lighting fixture retrofitted with an LED-based lighting subassembly, according to another embodiment of the disclosure.

FIG. 5 is a diagram illustrating a conventional lighting fixture retrofitted with an LED-based lighting subassembly having two parallel linear arrays of LEDs, according to another embodiment of the disclosure.

FIG. 6 is a diagram illustrating a hanging lighting fixture retrofitted with multiple LED-based lighting subassemblies, according to another embodiment of the disclosure.

FIG. 7 is a diagram illustrating a lighting fixture retrofitted with multiple LED-based lighting subassemblies to provide both up-lighting and down-lighting, according to another embodiment of the disclosure.

FIG. 8 is a diagram illustrating a circular or oval shaped mechanical support for a retrofit subassembly, according to another embodiment of the disclosure.

FIG. 9 is a diagram illustrating an L-shaped mechanical support for a retrofit subassembly, according to another embodiment of the disclosure.

FIG. 10 is a diagram illustrating a U-shaped mechanical support for a retrofit subassembly, according to another embodiment of the disclosure.

FIG. 11 is a diagram illustrating an essentially flat panel mechanical support for a retrofit subassembly, according to another embodiment of the disclosure.

FIG. 12 is a diagram illustrating a networked lighting system according to one embodiment of the disclosure, including multiple modified lighting fixtures having LED-based retrofit subassemblies.

### DETAILED DESCRIPTION

Various embodiments of the present disclosure are described below, including certain embodiments relating particularly to LED-based light sources. It should be appreciated, however, that the present disclosure is not limited to any particular manner of implementation, and that the various embodiments discussed explicitly herein are primarily for purposes of illustration. For example, the various concepts discussed herein may be suitably implemented in a variety of environments involving LED-based light sources, and environments that involve both LEDs and other types of light sources in combination.

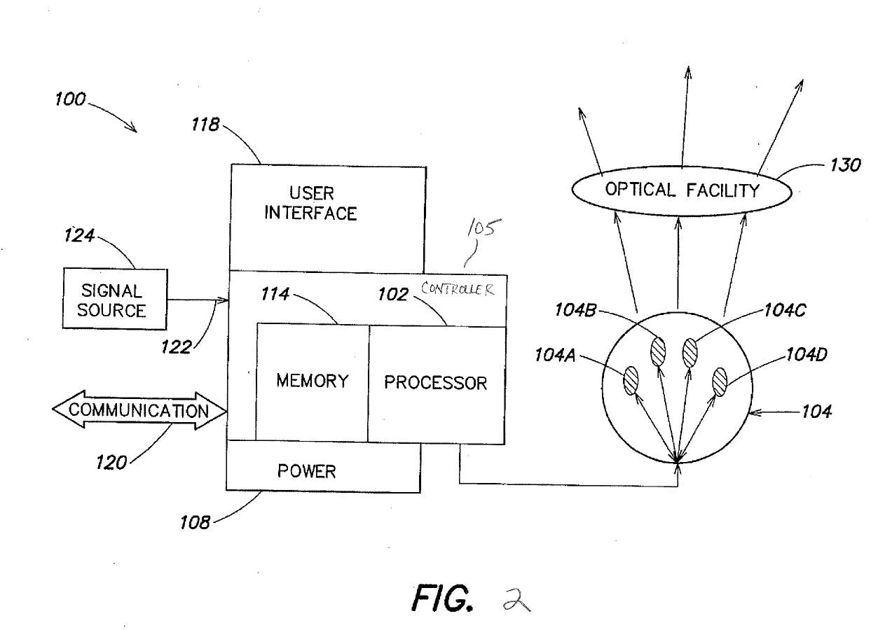

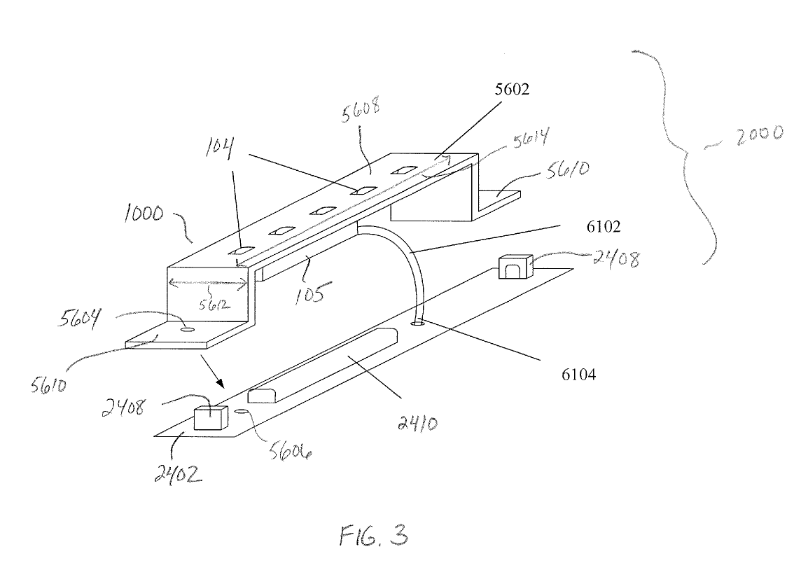

FIG. 2 is a diagram illustrating various elements of an LED-based lighting apparatus 100 that may serve as a retrofit subassembly for a conventional lighting fixture, according to one embodiment of the disclosure. In various embodiments of the present disclosure, the lighting apparatus 100 shown in FIG. 2 may be used alone or together with other similar lighting apparatus in a system of lighting apparatus or fixtures (e.g., as discussed further below in connection with FIG. 3). Used alone or in combination with other lighting apparatus, a lighting fixture retrofitted with the apparatus 100 may be employed in a variety of applications including, but not limited to, interior or exterior space (e.g., architectural) lighting and illumination in general, direct or indirect illumination of objects or spaces, theatrical or other entertainment-based/special effects lighting, decorative lighting, safety-oriented lighting, vehicular lighting, lighting associated with, or illumination of, displays and/or merchandise (e.g. for advertising and/or in retail/consumer environments), combined lighting or illumination and communication systems, etc., as well as for various indication, display and informational purposes.

In one embodiment, the lighting apparatus 100 shown in FIG. 2 may include one or more light sources 104A, 104B, 104C, and 104D (indicated generally as 104), wherein one or more of the light sources may be an LED-based light source that includes one or more light emitting diodes (LEDs). In one aspect of this embodiment, any two or more of the light sources may be adapted to generate radiation of different colors (e.g. red, green, blue); in this respect, as discussed above, each of the different color light sources generates a different source spectrum that constitutes a different “channel” of a “multi-channel” lighting apparatus. Although FIG. 2 shows four light sources 104A, 104B, 104C, and 104D, it should be appreciated that the lighting apparatus is not limited in this respect, as different numbers and various types of light sources (all LED-based light sources, LED-based and non-LED-based light sources in combination, etc.) adapted to generate radiation of a variety of different colors or a same color, including essentially white light, may be employed in the lighting apparatus 100, as discussed further below.

As shown in FIG. 2, the lighting apparatus 100 also may include a controller 105 that is configured to output one or more control signals to drive the light sources so as to generate various intensities of light from the light sources. For example, in one implementation, the controller 105 may be configured to output at least one control signal for each light source so as to independently control the intensity of light (e.g., radiant power in lumens) generated by each light source; alternatively, the controller 105 may be configured to output one or more control signals to collectively control a group of two or more light sources identically. Some examples of control signals that may be generated by the controller to control the light sources include, but are not limited to, pulse modulated signals, pulse width modulated signals (PWM), pulse amplitude modulated signals (PAM), pulse code modulated signals (PCM) analog control signals (e.g., current control signals, voltage control signals), combinations and/or modulations of the foregoing signals, or other control signals. In one aspect, particularly in connection with LED-based sources, one or more modulation techniques provide for variable control using a fixed current level applied to one or more LEDs, so as to mitigate potential undesirable or unpredictable variations in LED output that may arise if a variable LED drive current were employed. In another aspect, the controller 105 may control other dedicated circuitry (not shown in FIG. 2) which in turn controls the light sources so as to vary their respective intensities.

In general, the intensity (radiant output power) of radiation generated by the one or more light sources is proportional to the average power delivered to the light source(s) over a given time period. Accordingly, one technique for varying the intensity of radiation generated by the one or more light sources involves modulating the power delivered to (i.e., the operating power of) the light source(s). For some types of light sources, including LED-based sources, this may be accomplished effectively using a pulse width modulation (PWM) technique.

In one exemplary implementation of a PWM control technique, for each channel of a lighting apparatus a fixed predetermined voltage V_{source} is applied periodically across a given light source constituting the channel. The application of the voltage V_{source} may be accomplished via one or more switches, not shown in FIG. 2, controlled by the controller 105. While the voltage V_{source} is applied across the light source, a predetermined fixed current I_{source} (e.g., determined by a current regulator, also not shown in FIG. 2) is allowed to flow through the light source. Again, recall that an LED-based light source may include one or more LEDs, such that the voltage V_{source} may be applied to a group of LEDs constituting the source, and the current source may be drawn by the group of LEDs. The fixed voltage V_{source} across the light source when energized, and the regulated current I_{source} drawn by the light source when energized, determines the amount of instantaneous operating power P_{source} of the light source (P_{source}=V_{source}·I_{source}). As mentioned above, for LED-based light sources, using a regulated current mitigates potential undesirable or unpredictable variations in LED output that may arise if a variable LED drive current were employed.

According to the PWM technique, by periodically applying the voltage V_{source} to the light source and varying the time the voltage is applied during a given on-off cycle, the average power delivered to the light source over time (the average operating power) may be modulated. In particular, the controller 105 may be configured to apply the voltage V_{source} to a given light source in a pulsed fashion (e.g., by outputting a control signal that operates one or more switches to apply the voltage to the light source), preferably at a frequency that is greater than that capable of being detected by the human eye (e.g., greater than approximately 100 Hz). In this manner, an observer of the light generated by the light source does not perceive the discrete on-off cycles (commonly referred to as a “flicker effect”), but instead the integrating function of the eye perceives essentially continuous light generation. By adjusting the pulse width (i.e. on-time, or “duty cycle”) of on-off cycles of the control signal, the controller varies the average amount of time the light source is energized in any given time period, and hence varies the average operating power of the light source. In this manner, the perceived brightness of the generated light from each channel in turn may be varied.

As discussed in greater detail below, the controller 105 may be configured to control each different light source channel of a multi-channel lighting apparatus at a predetermined average operating power to provide a corresponding radiant output power for the light generated by each channel. Alternatively, the controller 105 may receive instructions (e.g., “lighting commands”) from a variety of origins, such as a user interface 118, a signal source 124, or one or more communication ports 120, that specify prescribed operating powers for one or more channels and, hence, corresponding radiant output powers for the light generated by the respective channels. By varying the prescribed operating powers for one or more channels (e.g., pursuant to different instructions or lighting commands), different perceived colors and brightnesses of light may be generated by the lighting apparatus.

In one embodiment of the lighting apparatus 100, as mentioned above, one or more of the light sources 104A, 104B, 104C, and 104D shown in FIG. 2 may include a group of multiple LEDs or other types of light sources (e.g., various parallel and/or serial connections of LEDs or other types of light sources) that are controlled together by the controller 105. Additionally, it should be appreciated that one or more of the light sources may include one or more LEDs that are adapted to generate radiation having any of a variety of spectra (i.e., wavelengths or wavelength bands), including, but not limited to, various visible colors (including essentially white light), various color temperatures of white light, ultraviolet, or infrared. LEDs having a variety of spectral bandwidths (e.g., narrow band, broader band) may be employed in various implementations of the lighting apparatus 100.

In another aspect of the lighting apparatus 100 shown in FIG. 2, the lighting apparatus 100 may be constructed and arranged to produce a wide range of variable color radiation. For example, in one embodiment, the lighting apparatus 100 may be particularly arranged such that controllable variable intensity (i.e., variable radiant power) light generated by two or more of the light sources combines to produce a mixed colored light (including essentially white light having a variety of color temperatures). In particular, the color (or color temperature) of the mixed colored light may be varied by varying one or more of the respective intensities (output radiant power) of the light sources (e.g., in response to one or more control signals output by the controller 105). Furthermore, the controller 105 may be particularly configured to provide control signals to one or more of the light sources so as to generate a variety of static or time-varying (dynamic) multi-color (or multi-color temperature) lighting effects. To this end, in one embodiment, the controller may include a processor 102 (e.g., a microprocessor) programmed to provide such control signals to one or more of the light sources. In various aspects, the processor 102 may be programmed to provide such control signals autonomously, in response to lighting commands, or in response to various user or signal inputs.

Thus, the lighting apparatus 100 may include one or more LEDs of only a single color, or a wide variety of colors of LEDs in various combinations, including two or more of red, green, and blue LEDs to produce a color mix, as well as one or more other LEDs to create varying colors and color temperatures of white light. For example, red, green and blue can be mixed with amber, white, UV, orange, IR or other colors of LEDs. Such combinations of differently colored LEDs in the lighting apparatus 100 can facilitate accurate reproduction of a host of desirable spectrums of lighting conditions, examples of which include, but are not limited to, a variety of outside daylight equivalents at different times of the day, various interior lighting conditions, lighting conditions to simulate a complex multicolored background, and the like. Other desirable lighting conditions can be created by removing particular pieces of spectrum that may be specifically absorbed, attenuated or reflected in certain environments. Water, for example tends to absorb and attenuate most non-blue and non-green colors of light, so underwater applications may benefit from lighting conditions that are tailored to emphasize or attenuate some spectral elements relative to others.

As shown in FIG. 2, the lighting apparatus 100 also may include a memory 114 to store various information. For example, the memory 114 may be employed to store one or more lighting commands or programs for execution by the processor 102 (e.g., to generate one or more control signals for the light sources), as well as various types of data useful for generating variable color radiation. The memory 114 also may store one or more particular identifiers (e.g., a serial number, an address, etc.) that may be used either locally or on a system level to identify the lighting apparatus 100. In various embodiments, such identifiers may be pre-programmed by a manufacturer, for example, and may be either alterable or non-alterable thereafter (e.g., via some type of user interface located on the lighting apparatus, via one or more data or control signals received by the lighting apparatus, etc.). Alternatively, such identifiers may be determined at the time of initial use of the lighting apparatus in the field, and again may be alterable or non-alterable thereafter.

In another aspect, as also shown in FIG. 2, the lighting apparatus 100 optionally may include one or more user interfaces 118 that are provided to facilitate any of a number of user-selectable settings or functions (e.g., generally controlling the light output of the lighting apparatus 100, changing and/or selecting various pre-programmed lighting effects to be generated by the lighting apparatus, changing and/or selecting various parameters of selected lighting effects, setting particular identifiers such as addresses or serial numbers for the lighting apparatus, etc.). In various embodiments, the communication between the user interface 118 and the lighting apparatus may be accomplished through wire or cable, or wireless transmission.

In one implementation, the processor 102 of the lighting apparatus monitors the user interface 118 and controls one or more of the light sources 104A, 104B, 104C and 104D based at least in part on a user's operation of the interface. For example, the controller 105 may be configured to respond to operation of the user interface by originating one or more control signals for controlling one or more of the light sources. Alternatively, the controller 105 may be configured to respond by selecting one or more pre-programmed control signals stored in memory, modifying control signals generated by executing a lighting program, selecting and executing a new lighting program from memory, or otherwise affecting the radiation generated by one or more of the light sources.

In particular, in one implementation, the user interface 118 may constitute one or more switches (e.g., a standard wall switch) that interrupt power to the controller 105. In one aspect of this implementation, the controller 105 is configured to monitor the power as controlled by the user interface, and in turn control one or more of the light sources based at least in part on a duration of a power interruption caused by operation of the user interface. As discussed above, the processor 102 may be particularly configured to respond to a predetermined duration of a power interruption by, for example, selecting one or more pre-programmed control signals stored in memory, modifying control signals generated by executing a lighting program, selecting and executing a new lighting program from memory, or otherwise affecting the radiation generated by one or more of the light sources.

FIG. 2 also illustrates that the lighting apparatus 100 may be configured to receive one or more signals 122 from one or more other signal sources 124. In one implementation, the controller 105 of the lighting apparatus may use the signal(s) 122, either alone or in combination with other control signals (e.g., signals generated by executing a lighting program, one or more outputs from a user interface, etc.), so as to control one or more of the light sources 104A, 104B, 104C and 104D in a manner similar to that discussed above in connection with the user interface.

Examples of the signal(s) 122 that may be received and processed by the controller 105 include, but are not limited to, one or more audio signals, video signals, power signals, various types of data signals, signals representing information obtained from a network (e.g., the Internet), signals representing one or more detectable/sensed conditions, signals from lighting apparatus, signals consisting of modulated light, etc. In various implementations, the signal source(s) 124 may be located remotely from the lighting apparatus 100, or included as a component of the lighting apparatus. In one embodiment, a signal from one lighting apparatus 100 could be sent over a network to another lighting apparatus 100.

Some examples of a signal source 124 that may be employed in, or used in connection with, the lighting apparatus 100 of FIG. 2 include any of a variety of sensors or transducers that generate one or more signals 122 in response to some stimulus. Examples of such sensors include, but are not limited to, various types of environmental condition sensors, such as thermally sensitive (e.g., temperature, infrared) sensors, humidity sensors, motion sensors, photosensors/light sensors (e.g., photodiodes, sensors that are sensitive to one or more particular spectra of electromagnetic radiation such as spectroradiometers or spectrophotometers, etc.), various types of cameras, sound or vibration sensors or other pressure/force transducers (e.g., microphones, piezoelectric devices), and the like.

Additional examples of a signal source 124 include various metering/detection devices that monitor electrical signals or characteristics (e.g., voltage, current, power, resistance, capacitance, inductance, etc.) or chemical/biological characteristics (e.g., acidity, a presence of one or more particular chemical or biological agents, bacteria, etc.) and provide one or more signals 122 based on measured values of the signals or characteristics. Yet other examples of a signal source 124 include various types of scanners, image recognition systems, voice or other sound recognition systems, artificial intelligence and robotics systems, and the like. A signal source 124 could also be a lighting apparatus 100, a processor 102, or any one of many available signal generating devices, such as media players, MP3 players, computers, DVD players, CD players, television signal sources, camera signal sources, microphones, speakers, telephones, cellular phones, instant messenger devices, SMS devices, wireless devices, personal organizer devices, and many others.

In one embodiment, the lighting apparatus 100 shown in FIG. 2 also may include one or more optical elements 130 to optically process the radiation generated by the light sources 104A, 104B, 104C, and 104D. For example, one or more optical elements may be configured so as to change one or both of a spatial distribution and a propagation direction of the generated radiation. In particular, one or more optical elements may be configured to change a diffusion angle of the generated radiation. In one aspect of this embodiment, one or more optical elements 130 may be particularly configured to variably change one or both of a spatial distribution and a propagation direction of the generated radiation (e.g., in response to some electrical and/or mechanical stimulus). Examples of optical elements that may be included in the lighting apparatus 100 include, but are not limited to, reflective materials, refractive materials, translucent materials, filters, lenses, mirrors, and fiber optics. The optical element 130 also may include a phosphorescent material, luminescent material, or other material capable of responding to or interacting with the generated radiation.

As also shown in FIG. 2, the lighting apparatus 100 may include one or more communication ports 120 to facilitate coupling of the lighting apparatus 100 to any of a variety of other devices. For example, one or more communication ports 120 may facilitate coupling multiple lighting apparatus together as a networked lighting system, in which at least some of the lighting apparatus are addressable (e.g., have particular identifiers or addresses) and are responsive to particular data transported across the network.

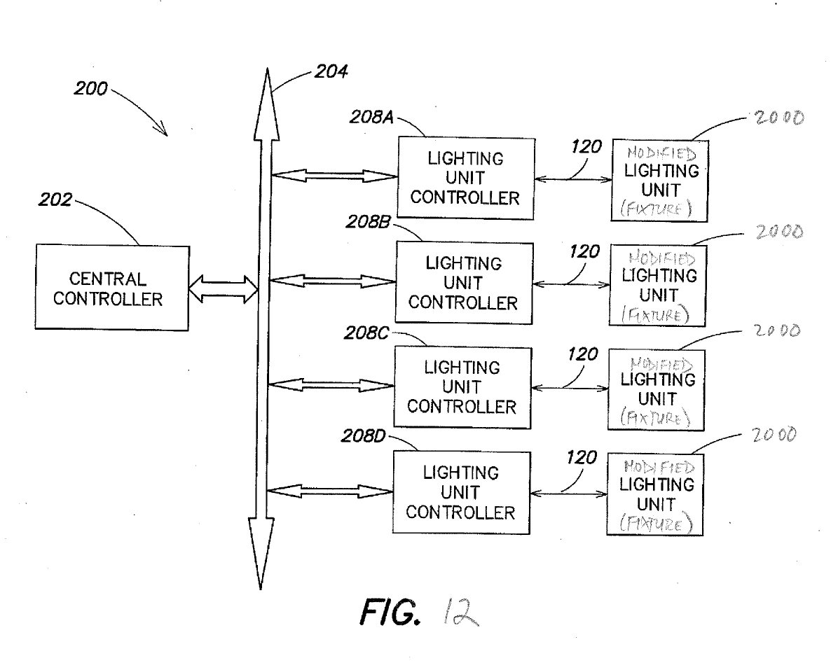

In particular, in a networked lighting system environment, as discussed in greater detail further below (e.g., in connection with FIG. 12), as data is communicated via the network, the controller 105 of each lighting apparatus coupled to the network may be configured to be responsive to particular data (e.g., lighting control commands) that pertain to it (e.g., in some cases, as dictated by the respective identifiers of the networked lighting apparatus). Once a given controller identifies particular data intended for it, it may read the data and, for example, change the lighting conditions produced by its light sources according to the received data (e.g., by generating appropriate control signals to the light sources). In one aspect, the memory 114 of each lighting apparatus coupled to the network may be loaded, for example, with a table of lighting control signals that correspond with data the controller 105 receives. Once the controller 105 receives data from the network, the controller may consult the table to select the control signals that correspond to the received data, and control the light sources of the lighting apparatus accordingly.

In one aspect of this embodiment, the processor 102 of a given lighting apparatus, whether or not coupled to a network, may be configured to interpret lighting instructions/data that are received in a DMX protocol (as discussed, for example, in U.S. Pat. Nos. 6,016,038 and 6,211,626), which is a lighting command protocol conventionally employed in the lighting industry for some programmable lighting applications. For example, in one aspect, considering for the moment a lighting apparatus based on red, green and blue LEDs (i.e., an “R-G-B” lighting apparatus), a lighting command in DMX protocol may specify each of a red channel command, a green channel command, and a blue channel command as eight-bit data (i.e., a data byte) representing a value from 0 to 255. The maximum value of 255 for any one of the color channels instructs the processor 102 to control the corresponding light source(s) to operate at maximum available power (i.e., 100%) for the channel, thereby generating the maximum available radiant power for that color (such a command structure for an R-G-B lighting apparatus commonly is referred to as 24-bit color control). Hence, a command of the format [R, G, B]=[255, 255, 255] would cause the lighting apparatus to generate maximum radiant power for each of red, green and blue light (thereby creating white light).

It should be appreciated, however, that lighting apparatus suitable for purposes of the present disclosure are not limited to a DMX command format, as lighting apparatus according to various embodiments may be configured to be responsive to other types of communication protocols/lighting command formats so as to control their respective light sources. In general, the controller 105 may be configured to respond to lighting commands in a variety of formats that express prescribed operating powers for each different channel of a multi-channel lighting apparatus according to some scale representing zero to maximum available operating power for each channel.

In one embodiment, the lighting apparatus 100 of FIG. 2 may include and/or be coupled to one or more power sources 108. In various aspects, examples of power source(s) 108 include, but are not limited to, AC power sources, DC power sources, batteries, solar-based power sources, thermoelectric or mechanical-based power sources and the like. Additionally, in one aspect, the power source(s) 108 may include or be associated with one or more power conversion devices that convert power received by an external power source to a form suitable for operation of the lighting apparatus 100.

According to other embodiments of the present disclosure, various elements of the lighting apparatus 100 discussed above in connection with FIG. 2 may be incorporated into an LED-based lighting subassembly for retrofitting into a conventional lighting fixture, including fluorescent lighting fixtures. In various aspects, retrofit subassemblies may employ a variety of mechanical (and electrical) support configurations to facilitate outfitting a conventional lighting fixture with LED light sources.

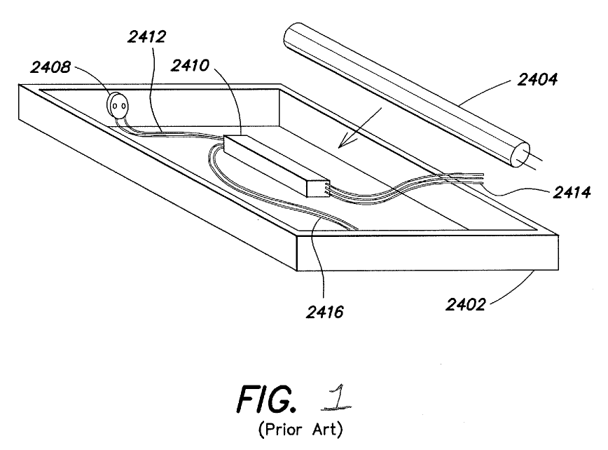

For example, FIG. 3 is a diagram illustrating a modified conventional lighting fixture 2000 retrofitted with an LED-based retrofit subassembly 1000, according to one embodiment of the present disclosure. The retrofit subassembly 1000 may incorporate various elements of the lighting apparatus 100 discussed above in connection with FIG. 2. In one implementation, the modified fixture 2000 in which the subassembly 1000 is retrofitted may be a conventional fluorescent lighting fixture (as illustrated, for example, in FIG. 1).

In particular, FIG. 3 shows a portion (i.e., a back panel) of a fluorescent fixture housing 2402, on which is mounted a ballast 2410 and fluorescent bulb connectors 2408. In one aspect, the retrofit subassembly 1000 is configured to be attachable to the housing 2402 of the fluorescent fixture once one or more fluorescent bulbs have been removed from the fixture. However, the subassembly 1000 need not be configured so as to specifically replace the fluorescent bulb(s) per se (i.e., the subassembly need not be shaped to resemble a fluorescent tube, make any electrical or mechanical connections with the connectors 2408, or rely on the ballast 2410 for electrical signals). Rather, the subassembly merely attaches to the fixture housing to completely replace the original operating components of the conventional fixture. Thus, the subassembly 1000 provides a convenient apparatus for retrofitting pre-existing conventional lighting fixtures that may be incorporated as fixed or recessed structures in an architectural environment.

As shown in FIG. 3, the subassembly 1000 according to one embodiment includes a mechanical support 5602 to which one or more LEDs (labeled generally with the reference numeral 104) of the lighting apparatus 100 are coupled. The mechanical support 5602 includes one or more features that are configured to facilitate an attachment of the mechanical support to the housing 2402 of the conventional fluorescent lighting fixture. For example, as illustrated in FIG. 3, the mechanical support 5602 may include one or more screw holes 5604 that are aligned with one or more complimentary screw holes 5606 in the housing 2402 when the subassembly 1000 is appropriately positioned in the housing. Alternatively, while not shown explicitly in FIG. 3, the mechanical support (and/or the housing) may include one or more clips to facilitate fastening the subassembly to the fixture housing.

In one exemplary implementation, the controller 105 of the LED-based lighting apparatus 100 (shown in FIG. 2) also may be coupled to the mechanical support 5602. As discussed above, the controller 105 may be configured to control at least an intensity of radiation generated by one or more of the LEDs 104. As also discussed above, while a number of LEDs are indicated generally in FIG. 3, it should be appreciated that the LEDs coupled to the mechanical support may include LEDs all having a same color or LEDs of different colors, including white LEDs (having various color temperatures).

In embodiments involving multiple different-color LEDs, the subassembly may constitute a “multi-channel” device, wherein the controller 105 is configured to independently control different channels of the subassembly to generate variable color and/or variable color temperature light. Additionally, in various aspects, the controller 105 may include a processor and memory, may be configured as an addressable controller, and may be configured to receive various signals from one or more of a user interface, a signal source, or a communication port, as discussed above in connection with FIG. 2. In one aspect shown in FIG. 3, a cable 6102 including multiple conductors may be coupled to the controller 105 and routed through a cut-out or hole 6102 in the housing to provide power or other signal connections to the controller 105.

As also depicted in FIG. 3, the mechanical support 5602 may be configured as a U-shaped member having an elevated central portion 5608 to which at least one or more LEDs are coupled, and two flanking portions 5610 on opposing sides of the elevated central portion. In this manner, the mechanical support may provide some clearance between elements of the lighting apparatus included in the subassembly 1000 (such as the controller 105) and original components of the fixture (e.g., the ballast 2410), so as to facilitate retrofitting without having to remove any original fixture components other than the fluorescent bulb(s). FIG. 3 shows that one or more screw holes 5604, or other features for attaching the subassembly to the housing, may be included in the flanking portions 5610 of the mechanical support. In another aspect, the mechanical support 5602 may be made of a thermally conductive material (e.g., metal) so as to provide a thermal conduction path to transmit heat from the vicinity of the LEDs 104 and/or the controller 105 so as to be dissipated by the housing 2402 of the fixture.

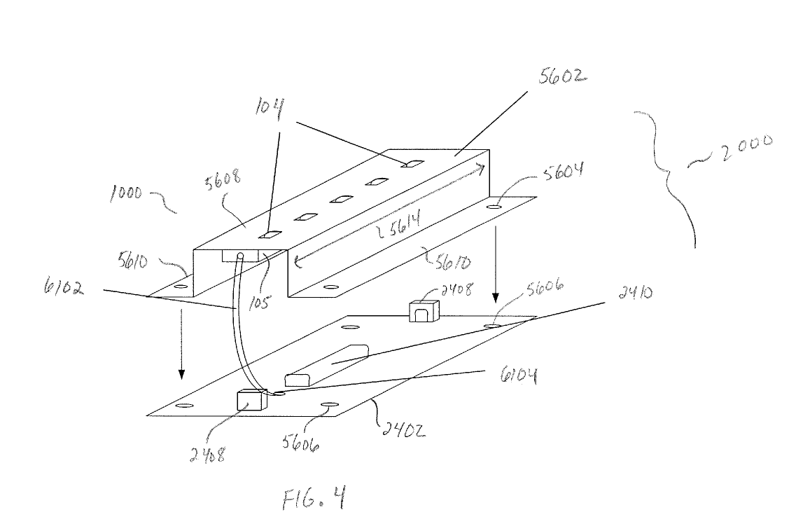

Due to the typically elongate shape of many conventional fluorescent lighting fixtures, in one embodiment the elevated central portion 5608 of the mechanical support 5602 itself has an elongate shape defined by a first dimension 5614 and a second dimension 5612 orthogonal to the first dimension in a plane of the elevated central portion, wherein the first dimension is longer than the second dimension. In the embodiment shown in FIG. 3, the two flanking portions 5610 are disposed on the opposing sides of the elevated central portion along the second dimension 5612. In another embodiment shown in FIG. 4, the two flanking portions 5610 may be disposed on opposing sides of the elevated central portion along the first dimension 5614.

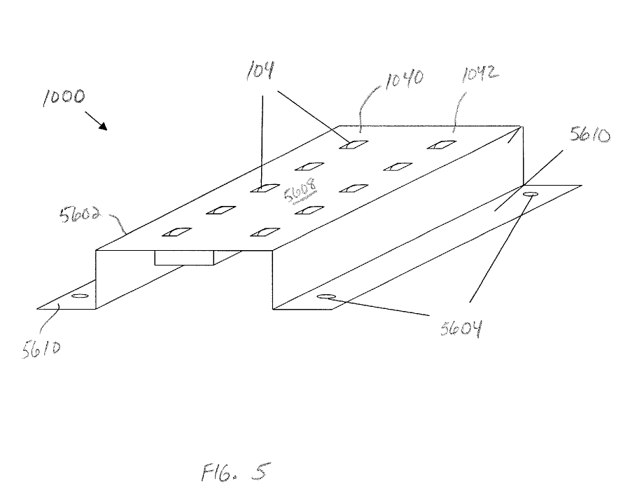

As illustrated in both FIGS. 3 and 4, in another aspect, a plurality of LEDs 104 coupled to the mechanical support 5602 may be arranged in at least one essentially linear array along the elevated central portion 5608 of the mechanical support. In another configuration illustrated in FIG. 5, the plurality of LEDs 104 may be arranged in at least two essentially linear parallel arrays 1040 and 1042 along the elevated central portion of the mechanical support. It should be appreciated, however, that the configurations of LEDs depicted in FIGS. 3-5 are provided primarily for purposes of illustrating some exemplary arrangements of LEDs, and that the present disclosure is not limited to these arrangements.

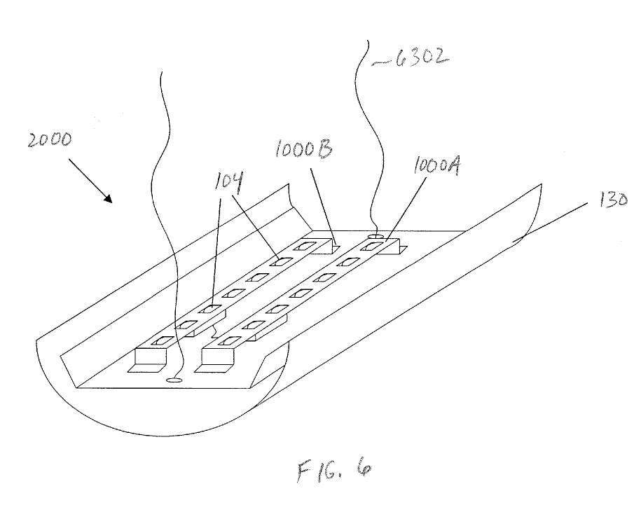

In one implementation, as illustrated in FIG. 6, a modified conventional fixture including an LED-based retrofit subassembly 1000 may be configured as a hanging or pendant lighting fixture that may be suspended from a ceiling via supports 6302 (e.g., cables, pipes, etc.). In one aspect of the fixture shown in FIG. 6, multiple LED-based subassemblies 1000A and 1000B are employed, illustrating that a variety of retrofit configurations are possible using one or multiple subassemblies. In addition to the various components discussed above, a hanging or other type of modified conventional fixture including one or more LED-based subassemblies may include one or more optical components 130 through which light generated by the one or more subassemblies passes. Some examples of such optical components include, but are not limited to, a diffuser, a transparent or translucent window, one or more lenses, and the like. In one aspect, such optical components also may provide for protecting other components of the fixture from exposure to the environment and ensuring safe operation of the fixture by impeding direct access to other components of the fixture.

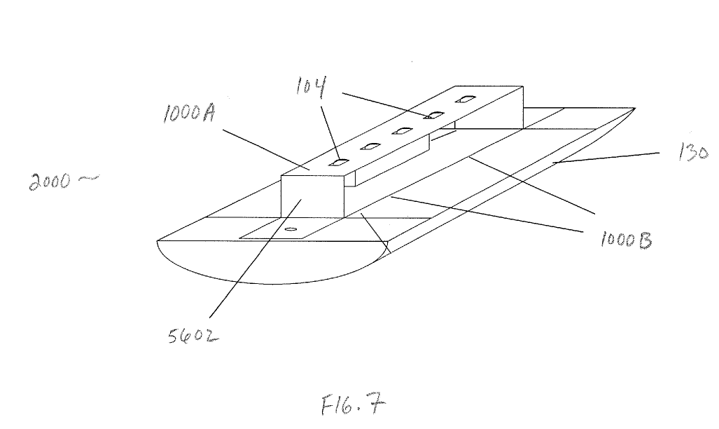

FIG. 7 is a diagram illustrating yet another modified lighting fixture retrofitted with multiple LED-based lighting subassemblies according to the present disclosure, which is configured to provide both up-lighting and down-lighting functions. In particular, the fixture 2000 shown in the embodiment of FIG. 7 includes a first subassembly 1000A (visible in the perspective view of the figure) to provide upwardly directed light, and a second subassembly 1000B (not entirely visible in the perspective view of the figure) disposed in an opposite facing direction from the first subassembly so as to provide downwardly directed light through the optical component 6304.

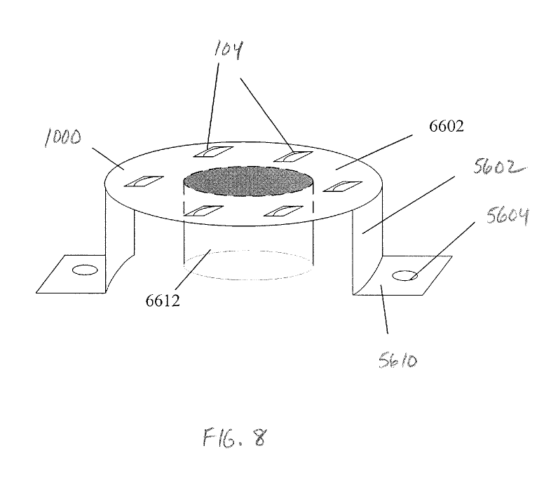

FIG. 8 is a diagram illustrating another embodiment of an LED-based retrofit subassembly 1000 in which the mechanical support 5602 has an essentially circular or oval shaped elevated central portion 6602 to which the LEDs 104 are coupled. While the subassembly 1000 shown in FIG. 8 may find utility for retrofitting a variety of conventional lighting fixtures, including fluorescent fixtures, the form of the subassembly FIG. 8 may be particularly suited for incandescent or halogen retrofitting applications. For example, in one implementation, the subassembly of FIG. 8 may be positioned over a conventional incandescent or halogen lighting socket 6612 and secured via the features 5604. In one aspect, the configuration of the subassembly may facilitate retrofitting without having to remove a pre-existing incandescent socket, but rather merely leaving the socket 6612 in place and installing the subassembly around the socket. In another aspect, the subassembly may be configured to include features to actually engage mechanically and or electrically with the socket so as to derive power from the socket 6612, or power and data via a power/data protocol (e.g., as discussed in U.S. Pat. No. 6,292,901, hereby incorporated herein by reference).

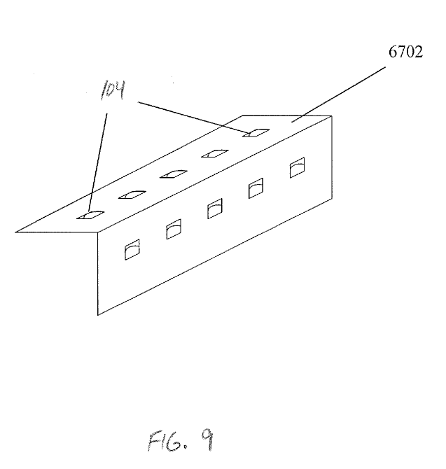

FIG. 9 depicts a subassembly configuration according to another embodiment including an L-shaped mechanical support 6702 in which LED light sources 104 are disposed substantially in lines along two planes that are substantially perpendicular to each other. The support 6702 may be configured to fit over any surface that includes a corner, such as a corner of a wall, a ceiling, a floor, a rectangular fixture, or the like.

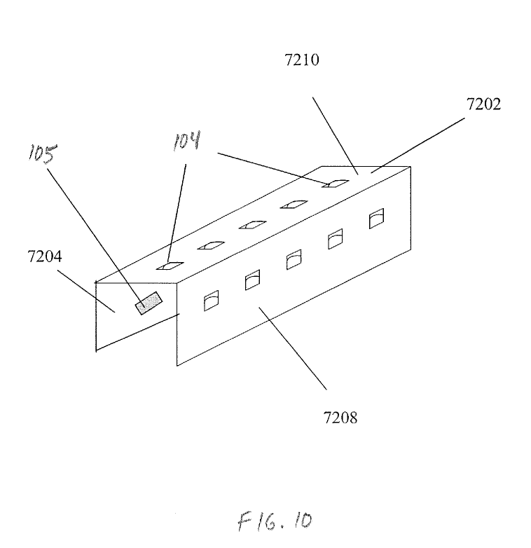

FIG. 10 depicts a subassembly configuration according to yet another embodiment including a U-shaped mechanical support 7302 with two or three sides to which one or more LEDs are coupled. In the configuration of FIG. 10, two opposite sides 7204, 7208 are substantially parallel, and both are attached to a top side 7210 that is perpendicular to both. One or more controllers similar to the controller 105 may be positioned on the back of one or more of the sides 7204, 7208, 7210 and associated with one or more corresponding LEDs coupled to a given side. The support 7302 can be designed to retrofit a conventional lighting fixture (e.g., a linear lighting fixture, a fluorescent fixture) pursuant to the various concepts discussed herein.

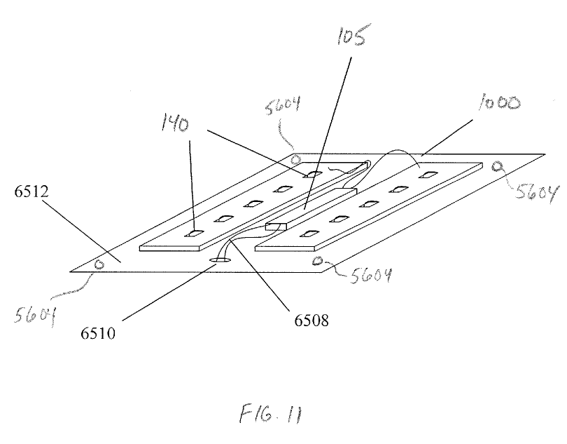

FIG. 11 depicts yet another configuration for a subassembly 1000 according to another embodiment, in which the subassembly includes a mechanical support 6512 that constitutes an essentially flat panel. As illustrated in FIG. 11, the mechanical support 6512 may be configured to support one or more arrays of LEDs 140, as well as one or more controllers 105. Cables 6508 coupled to one or more controller s 105 may be routed through a space 6510. Holes 5604 are provided to couple the subassembly to a fixture (e.g., a troffers-type fixture.)

FIG. 12 illustrates an example of a networked lighting system 200 according to one embodiment of the present disclosure. In the embodiment of FIG. 12, a number of modified lighting fixtures or lighting units 2000, similar to those discussed above in connection with any of FIGS. 3-9, are coupled together to form the networked lighting system. It should be appreciated, however, that the particular configuration and arrangement of lighting fixtures shown in FIG. 12 is for purposes of illustration only, and that the disclosure is not limited to the particular system topology shown in FIG. 12.

Additionally, while not shown explicitly in FIG. 12, it should be appreciated that the networked lighting system 200 may be configured flexibly to include one or more user interfaces, as well as one or more signal sources such as sensors/transducers. For example, one or more user interfaces and/or one or more signal sources such as sensors/transducers (as discussed above in connection with FIG. 2) may be associated with any one or more of the lighting fixtures of the networked lighting system 200. Alternatively (or in addition to the foregoing), one or more user interfaces and/or one or more signal sources may be implemented as “stand alone” components in the networked lighting system 200. Whether stand alone components or particularly associated with one or more lighting fixtures 2000, these devices may be “shared” by the lighting fixtures of the networked lighting system. Stated differently, one or more user interfaces and/or one or more signal sources such as sensors/transducers may constitute “shared resources” in the networked lighting system that may be used in connection with controlling any one or more of the lighting fixtures of the system.

As shown in the embodiment of FIG. 12, the lighting system 200 may include one or more lighting unit controllers (hereinafter “LUCs”) 208A, 208B, 208C, and 208D, wherein each LUC is responsible for communicating with and generally controlling one or more lighting fixtures 2000 coupled to it. Although FIG. 12 illustrates one lighting fixture 2000 coupled to each LUC, it should be appreciated that the disclosure is not limited in this respect, as different numbers of lighting fixtures may be coupled to a given LUC in a variety of different configurations (serially connections, parallel connections, combinations of serial and parallel connections, etc.) using a variety of different communication media and protocols.

In the system of FIG. 12, each LUC in turn may be coupled to a central controller 202 that is configured to communicate with one or more LUCs. Although FIG. 12 shows four LUCs coupled to the central controller 202 via a generic connection 204 (which may include any number of a variety of conventional coupling, switching and/or networking devices), it should be appreciated that according to various embodiments, different numbers of LUCs may be coupled to the central controller 202. Additionally, according to various embodiments of the present disclosure, the LUCs and the central controller may be coupled together in a variety of configurations using a variety of different communication media and protocols to form the networked lighting system 200. Moreover, it should be appreciated that the interconnection of LUCs and the central controller, and the interconnection of lighting fixtures to respective LUCs, may be accomplished in different manners (e.g., using different configurations, communication media, and protocols).

For example, according to one embodiment of the present disclosure, the central controller 202 shown in FIG. 12 may by configured to implement Ethernet-based communications with the LUCs, and in turn the LUCs may be configured to implement DMX-based communications with the lighting fixtures 2000. In particular, in one aspect of this embodiment, each LUC may be configured as an addressable Ethernet-based controller and accordingly may be identifiable to the central controller 202 via a particular unique address (or a unique group of addresses) using an Ethernet-based protocol. In this manner, the central controller 202 may be configured to support Ethernet communications throughout the network of coupled LUCs, and each LUC may respond to those communications intended for it. In turn, each LUC may communicate lighting control information to one or more lighting fixture coupled to it, for example, via a DMX protocol, based on the Ethernet communications with the central controller 202.

More specifically, according to one embodiment, the LUCs 208A, 208B, and 208C shown in FIG. 12 may be configured to be “intelligent” in that the central controller 202 may be configured to communicate higher level commands to the LUCs that need to be interpreted by the LUCs before lighting control information can be forwarded to the lighting fixtures 2000. For example, a lighting system operator may want to generate a color changing effect that varies colors from lighting fixture to lighting fixture in such a way as to generate the appearance of a propagating rainbow of colors (“rainbow chase”), given a particular placement of lighting fixtures with respect to one another. In this example, the operator may provide a simple instruction to the central controller 202 to accomplish this, and in turn the central controller may communicate to one or more LUCs using an Ethernet-based protocol high level command to generate a “rainbow chase.” The command may contain timing, intensity, hue, saturation or other relevant information, for example. When a given LUC receives such a command, it may then interpret the command and communicate further commands to one or more lighting fixtures using a DMX protocol, in response to which the respective sources of the lighting fixtures are controlled via any of a variety of signaling techniques (e.g., PWM).

It should again be appreciated that the foregoing example of using multiple different communication implementations (e.g., Ethernet/DMX) in a lighting system according to one embodiment of the present disclosure is for purposes of illustration only, and that the disclosure is not limited to this particular example.

From the foregoing, it may be appreciated that one or more lighting fixtures as discussed above are capable of generating highly controllable variable color light over a wide range of colors, as well as variable color temperature white light over a wide range of color temperatures, according to various embodiments of the present disclosure.

Having thus described several illustrative embodiments, it is to be appreciated that various alterations, modifications, and improvements will readily occur to those skilled in the art. Such alterations, modifications, and improvements are intended to be part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Accordingly, the foregoing description and attached drawings are by way of example only, and are not intended to be limiting.

1. A lighting retrofit apparatus comprising:
at least one first LED;
at least one controller coupled to the at least one first LED and configured to control at least a first intensity of first radiation generated by the at least one first LED; and
a mechanical support to which at least the at least one first LED is coupled, the mechanical support configured such that the lighting retrofit apparatus constitutes a subassembly that is attachable to a housing of a conventional lighting fixture.

2. The apparatus of claim 1, wherein the conventional lighting fixture is a conventional fluorescent lighting fixture.

3. The apparatus of claim 1, wherein the at least one controller is coupled to the mechanical support.

4. The apparatus of claim 1, wherein the mechanical support is configured essentially as a U-shaped member comprising:
an elevated central portion to which the at least one first LED is coupled; and
two flanking portions on opposing sides of the elevated central portion, each flanking portion including at least one feature configured to facilitate an attachment of the apparatus to the housing of the conventional lighting fixture.

5. The apparatus of claim 4, wherein the at least one feature configured to facilitate the attachment of the apparatus to the housing of the conventional lighting fixture includes at least one screw hole.

6. The apparatus of claim 4, wherein the elevated central portion has an elongate shape defined by a first dimension and a second dimension orthogonal to the first dimension in a plane of the elevated central portion, wherein the first dimension is longer than the second dimension.

7. The apparatus of claim 6, wherein the two flanking portions are disposed on the opposing sides of the elevated central portion along the first dimension.

8. The apparatus of claim 6, wherein the two flanking portions are disposed on the opposing sides of the elevated central portion along the second dimension.

9. The apparatus of claim 6, wherein the at least one first LED includes a plurality of LEDs arranged in at least one essentially linear array along the elevated central portion of the mechanical support.

10. The apparatus of claim 9, wherein the plurality of LEDs are arranged in at least two essentially linear parallel arrays along the elevated central portion of the mechanical support.

11. The apparatus of claim 9, wherein the at least one controller is coupled to the elevated central portion of the mechanical support.

12. The apparatus of claim 4, in combination with the housing of the conventional lighting fixture.

13. The combination of claim 12, wherein the conventional lighting fixture is configured as a hanging fluorescent lighting fixture, and wherein the apparatus constitutes a first retrofit subassembly that replaces at least one fluorescent tube of the hanging fluorescent lighting fixture.

14. The combination of claim 12, further comprising a second retrofit subassembly, wherein the second retrofit subassembly comprises:
at least one second LED-based lighting unit; and
a second mechanical support configured as a second essentially U-shaped member.

15. The apparatus of claim 1, wherein the mechanical support is configured as an essentially L-shaped member forming a first plane and a second plane.

16. The apparatus of claim 15, wherein the at least one LED includes at least a first LED coupled to the first plane and a second LED coupled to the second plane.

17. The apparatus of claim 15, wherein the at least one LED includes at least a first plurality of LEDs coupled to the first plane and a second plurality of LEDs coupled to the second plane.

18. The apparatus of claim 17, wherein each of the first plurality and second plurality of LEDs is arranged as at least one essentially linear array along the respective first and second planes.

19. A lighting fixture, comprising:
a housing of a conventional fluorescent lighting fixture; and
an LED-based retrofit subassembly coupled to the housing of the conventional fluorescent lighting fixture, wherein the LED-based retrofit subassembly does not engage with one or more conventional fluorescent bulb sockets of the conventional fluorescent lighting fixture.

20. The fixture of claim 19, wherein the retrofit subassembly comprises:
at least one first LED;
at least one controller coupled to the at least one first LED and configured to control at least a first intensity of first radiation having a first spectrum generated by the at least one first LED; and
a mechanical support to which at least the at least one first LED is coupled.

21. The fixture of claim 20, wherein:
the retrofit subassembly further comprises at least one second LED configured to generate second radiation having a second spectrum different than the first spectrum; and
the at least one controller is further configured to control at least a second intensity of the second radiation generated by the at least one second LED so as to control an overall color or color temperature of visible light generated by the fixture.

22. The fixture of claim 21, wherein the at least one controller is configured as an addressable controller to receive at least one lighting control command from a network connection, and wherein at least one of the color or color temperature of the visible light generated by the fixture is based at least in part on the at least one lighting command.

23. The fixture of claim 20, wherein the mechanical support is configured as an essentially U-shaped member comprising:
an elevated central portion to which the at least one first LED is coupled; and
two flanking portions on opposing sides of the elevated central portion, each flanking portion including at least one feature configured to facilitate an attachment of the retrofit subassembly to the housing of the conventional lighting fixture.

24. The fixture of claim 23, wherein the at least one first LED includes a plurality of LEDs arranged in at least one essentially linear array along the elevated central portion of the mechanical support.

25. The fixture of claim 24, wherein the plurality of LEDs are arranged in at least two essentially linear parallel arrays along the elevated central portion of the mechanical support.
